(19) United States
(12) Patent Application Publication
(10) Pub. No.: US 2011/0262713 A1
(43) Pub. Date: Oct. 27, 2011

(54) DECORATIVE MEMBER AND INJECTION MOLDING METHOD

(75) Inventors: Suguru Nakao, Hyogo (JP); Shuji Yamashita, Nara (JP); Takehiko Yamashita, Hyogo (JP); Takashi Nagashima, Kyoto (JP)

(73) Assignee: PANASONIC CORPORATION, Kadoma-shi, Osaka (JP)

(21) Appl. No.: 13/056,069

(22) PCT Filed: Dec. 25, 2009
(86) PCT No.: PCT/JP2009/007285

§ 371 Date: Jan. 26, 2011

(51) Int. Cl. B32B 3/00; B29C 45/00

(52) U.S. Cl. 428/174; 264/328.8

(57) ABSTRACT

A decorative member (1A) includes: a resin layer (2) having a front surface (2b) and a back surface (2a); and a reflective layer (3) formed on the back surface (2a) of the resin layer (2). The back surface (2a) of the resin layer (2) includes a receding surface (21) formed therein. The receding surface recedes gradually toward the front surface (2b) to change a thickness of the resin layer (2). The receding surface (21) is curved continuously along at least one direction perpendicular to a thickness direction of the resin layer (2) so as to be convex toward the front surface (2b).

### TECHNICAL FIELD

The technique disclosed herein relates to a decorative member that exhibits a pattern having a raised three-dimensional appearance, and an injection molding method for molding a resin layer composing the decorative member.

### BACKGROUND ART

Conventionally, as a decorative member for realizing a design with a three-dimensional visual effect, Patent Literature 1 has disclosed a decorative member 100 as shown in FIG. 13. In the decorative member 100, a transparent or translucent resin plate 200 has a back surface serrated with steep slopes 210 with a large inclination angle and gentle slopes 220 with a small inclination angle repeated alternately, and the back surface is covered with a colored layer 300.

The colored layer 300 has light reflecting capability. At portions of the colored layer 300 facing the gentle slopes 220, light that has entered the resin plate 200 through its front surface is reflected by the colored layer 300 so as to return to a front side. However, at portions of the colored layer 300 facing the steep slopes 210, the light is reflected by the colored layer 300 so as to veer in a lateral direction. This allows the colored layer 300 to look dark at portions corresponding to the steep slopes 210, forming a three-dimensional stripe pattern appearance.

### CITATION LIST

### Patent Literature

PTL 1: JP 58 (1983)-7494 B

### SUMMARY OF INVENTION

### Technical Problem

In Patent Literature 1, as is apparent from the fact that the term “colored layer” is used therein, the colored layer 300 represents the color of the pattern of the decorative member 100. However, in such a case where the colored layer 300 represents the color of the pattern of the decorative member 100, the ridges formed by providing the colored layer 300 along the two slopes 210, 220 do not look raised well, and the three-dimensional visual effect is not so high.

In view of the foregoing, the technique disclosed herein is intended to provide a decorative member with a high three-dimensional visual effect. The technique also is intended to provide an injection molding method for molding a resin layer composing the decorative member.

### Solution to Problem

One of the above-mentioned problems is solved by a decorative member including: a colored light-transmissive resin layer having a front surface and a back surface, the back surface including a receding surface formed therein, the receding surface receding gradually toward the front surface to change a thickness that is a distance between the front surface and the back surface; and a reflective layer formed on the back surface of the resin layer so as to cover the receding surface. The receding surface is curved continuously along at least one direction perpendicular to a thickness direction of the resin layer so as to be convex toward the front surface.

The other problem is solved by an injection molding method for molding the resin layer for the decorative member configured so that the decorative member extends in a specified direction and the receding surface extends in a longer direction of the decorative member. The injection molding method includes the step of, by using a metal mold having a molding chamber with the same shape as that of the resin layer, a first gate provided at a position corresponding to the lowest part of the molding chamber, and second gates provided at positions spaced apart from each other in a longer direction of the molding chamber with the first gate being located therebetween, injecting a melted resin from the second gates into the molding chamber and then injecting a melted resin from the first gate into the molding chamber.

### Advantageous Effects of Invention

In the above-mentioned decorative member, by changing, with the receding surface, the thickness of the colored resin layer, it is possible to form, on a convex portion formed by providing the reflective layer along the receding surface, a gradation of color that is pale at a thin portion of the resin layer and deep at a thick portion of the resin layer. Moreover, because of the transmission loss of light in the resin layer and the reflection of light by the reflective layer, the convex portion of the reflective layer along the receding surface looks bright at the thin portion of the resin layer and dark at the thick portion of the resin layer. With such a gradation having not only the lightness/depth of color but also the contrast of light utilizing the reflection of light, the convex portion of the reflective layer has a distinctly raised appearance. Thereby, a high three-dimensional visual effect can be obtained.

Furthermore, in the above-mentioned decorative member, since the receding surface is curved continuously, it is possible to change gradually and minutely the lightness/depth of color and the contrast of light in the gradation from the thin portion of the resin layer to the thick portion of the resin layer. Moreover, the degree of the gradation formed on the convex portion of the reflective layer varies in accordance with the angle at which the decorative member is viewed. Thereby, the three-dimensional visual effect can be accentuated further.

The above-mentioned injection molding method makes it possible to prevent the gas burning in the metal mold and to mold a weldless resin layer.

### BRIEF DESCRIPTION OF THE DRAWINGS

FIG. 1 is a perspective view of a decorative member according to Embodiment 1 of the present invention when viewed from a back side thereof.

FIG. 2 is a cross-sectional view of FIG. 1 taken along the line II-II.

FIG. 3 is a cross-sectional view of FIG. 1 taken along the line III-III.

FIG. 4 is a schematic view illustrating a state in which light that has entered a resin layer included in the decorative member shown in FIG. 1 through a front surface thereof is reflected by a reflective layer.

FIG. 5 is a view showing an appearance of the decorative member shown in FIG. 1 when viewed from a front side thereof.

FIG. 6 is a schematic view illustrating the flowability of a resin when the resin layer for the decorative member shown in FIG. 1 is injection-molded by an injection molding method according to one embodiment of the present invention.

FIG. 7 is a schematic view illustrating the flowability of the resin when the resin layer for the decorative member shown in FIG. 1 is injection-molded by an injection molding method according to a comparative example.

FIG. 8 is a view showing an appearance of the decorative member shown in FIG. 1 in a state in which a label is stuck on the front surface of the resin layer included therein.

FIG. 9 is a perspective view of a decorative member according to Embodiment 2 of the present invention when viewed from a back side thereof.

FIG. 10 is a cross-sectional view of one side of the decorative member shown in FIG. 9.

FIG. 11 is a view showing an appearance of the one side of the decorative member shown in FIG. 9 when viewed from a front side thereof.

FIG. 12A is a perspective view of a modified decorative member when viewed from a back side thereof, and FIG. 12B is a cross-sectional view of the decorative member.

FIG. 13 is a cross-sectional view of a conventional decorative member.

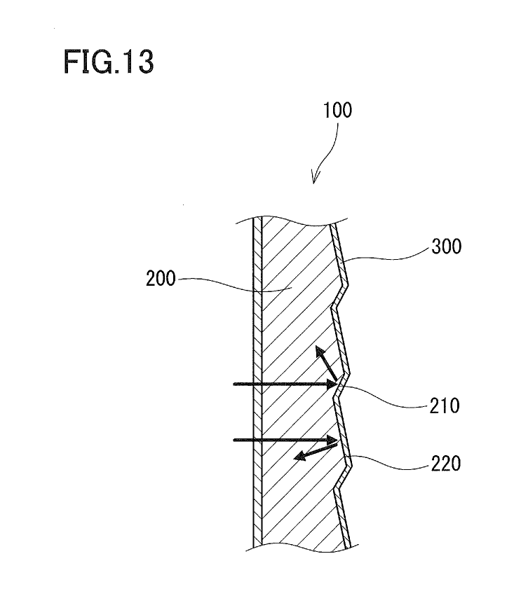

### DESCRIPTION OF EMBODIMENTS

Hereinafter, embodiments of the present invention will be described with reference to the drawings.

### Embodiment 1

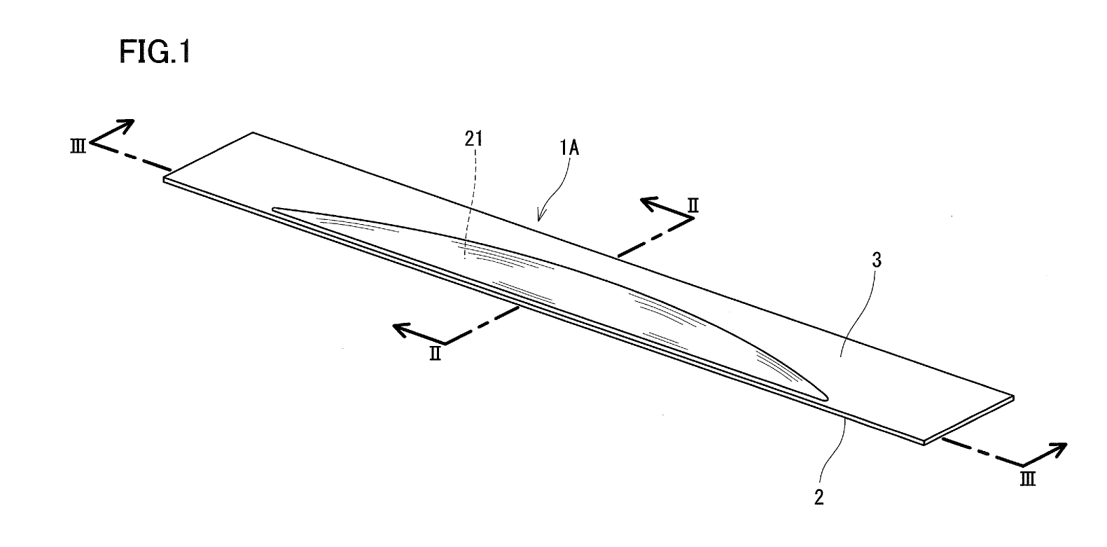

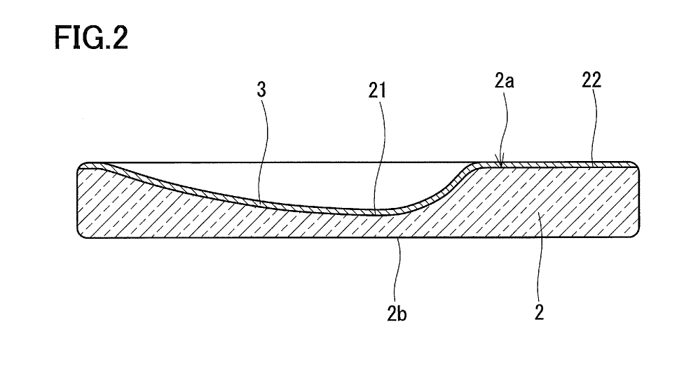

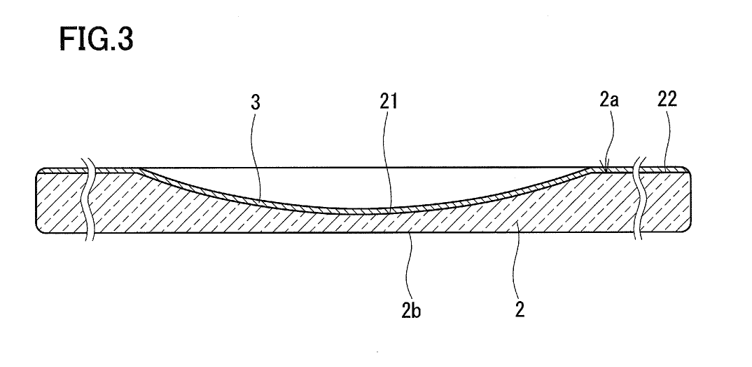

FIGS. 1 to 3 show a decorative member 1A according to Embodiment 1 of the present invention. The decorative member 1A has an approximately rectangular plate-like shape extending in a specified direction. The decorative member 1A has a resin layer 2 on a front side (on a bottom side in FIGS. 1 to 3), and a reflective layer 3 on a back side (on a top side in FIGS. 1 to 3).

The resin layer 2 is colored and light-transmissive. More specifically, the resin layer 2 allows light in a specified wavelength range of a visible light range to transmit therethrough, and absorbs or reflects light other than this. The color of the resin layer 2 is not particularly limited. Preferably, a relatively deep color (for example: black, red, and blue; or ACRYLITE produced by Mitsubishi Rayon Co., Ltd., color tone No. 530 (blue smoke), No. 540 (green smoke), No. 550 (brown smoke), and No. 83 (gray smoke)) is used. As the material composing the resin layer 2, various polymers, such as an acrylic resin, polycarbonate, ABS (acrylonitrile butadiene styrene), polyamide, and nylon, can be used independently or in combination as a polymer alloy.

The resin layer 2 has a front surface 2b that is one surface in a thickness direction thereof, and a back surface 2a that is the other surface in the thickness direction. The front surface 2b is a flat surface perpendicular to the thickness direction of the resin layer 2. In the back surface 2a, a receding surface 21 is formed. The receding surface 21 recedes gradually toward the front surface 2b to change a thickness that is a distance between the front surface 2b and the back surface 2a. In the present embodiment, the back surface 2a includes, outside the receding surface 21, a reference surface 22 that is parallel to the front surface 2b (in other words, the reference surface 22 is a flat surface perpendicular to the thickness direction of the resin layer 2.)

The receding surface 21 is curved continuously along at least one direction perpendicular to the thickness direction of the resin layer 2 so as to be convex toward the front surface 2b. As stated herein, the phrase “to be curved continuously” means that the gradient of a tangent of a cross-sectional shape of the receding surface 21 in a direction in which the receding surface 21 is curved varies in one-way direction from one end to the other end of the cross-sectional shape substantially continuously. It should be noted that the receding surface 21 may be formed in a linear curving manner with a constant curvature, or in a non-linear curving manner with a variable curvature. The term “substantially” indicates a concept including a case where: concave and convex portions such as those remaining on the surface during processing are ignored; and the gradient of a tangent of a cross-sectional shape of the receding surface 21 varies in one-way direction from one end to the other end of the cross-sectional shape continuously in a shape recognizable by human vision.

In the present embodiment, the receding surface 21 is a concave surface forming a depression that opens while broadening. In other words, the cross-sectional shape of the receding surface 21 in the direction in which the receding surface 21 is curved extends from one end to the other end so as to come closer to the front surface 2b and then go away therefrom. Furthermore, the concave surface of the present embodiment has a dome shape curved continuously along a longer direction and a shorter direction of the decorative member 1A (two directions perpendicular to each other and to the thickness direction of the resin layer 2). The reference surface 22 surrounds the receding surface 21.

The shape of the receding surface 21 in a plan view is not particularly limited. Preferably, the receding surface 21 extends in the longer direction of the decorative member 1A. For example, the shape of the receding surface 21 may be an elliptical shape or a strip-like shape with both ends being roundish, when viewed from the thickness direction of the resin layer 2.

A peripheral portion of the receding surface 21 may be joined directly to the reference surface 22 angularly so as to form a ridgeline with the reference surface 22. Alternatively, there may be provided a joint, having a cross-sectional shape that is convex in the direction opposite to that of the receding surface 21, annularly between the peripheral portion of the receding surface 21 and the reference surface 22, and the peripheral portion of the receding surface 21 may be joined smoothly to the reference surface 22 via the joint.

The resin layer 2 as mentioned above can be molded by a molding method such as injection molding, heating compression molding, and a combination of extrusion molding and heating compression molding. In molding the resin layer 2, it is preferable to use a mirror-finished metal mold in order to prevent the irregular reflection of light by the front surface 2b and to enhance the texture.

The reflective layer 3 is formed on the back surface 2a of the resin layer 2 so as to cover the receding surface 21 and the reference surface 22. The reflective layer 3 serves to reflect the light that has transmitted through the resin layer 2. Preferably, the reflective layer 3 essentially blocks light in the visible light range (approximately 400 to 750 nm) from transmitting therethrough, and has high reflectance to light essentially throughout the visible light range. From the viewpoint of regularly reflecting the light that has transmitted through the resin layer 2, a front surface of the reflective layer 3 contacting the receding surface 21 and the reference surface 22 of the resin layer 2 preferably is a lustrous smooth surface. For example, the transmittance of the reflective layer 3 to visible light preferably is 5% or less, more preferably 1% or less, and particularly preferably 0.1% or less. The reflectance and the smooth surface are expressed in terms of a gloss (luster) value of the front surface of the reflective layer 3. When the gloss value in the case where the brightness difference between incident light and receiving light is 10%, with the incident angle being 60 degree and the receiving angle being −60 degree on a glass surface (with a refractive index of 1.567), is taken as 100, the gloss value of the front surface of the reflective layer 3 preferably is 200 or more, more preferably 700 or more, and particularly preferably about 800.

Furthermore, the reflective layer 3 preferably has a metallic color. The reflective layer 3 can be composed of, for example: a coating film formed by coating a coating material containing a metallic pigment or a metallic colorant, or by printing a metallic ink; a metal film formed by vapor-depositing metal such as aluminum; or a metallic-colored sheet bonded to the back surface 2a of the resin layer 2.

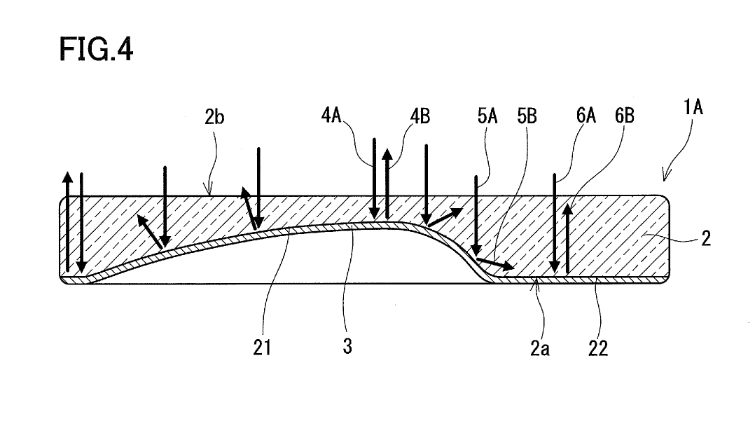

Next, the reflection of light that has entered the resin layer 2 included in the decorative member 1A through the front surface 2b thereof will be described with reference to FIG. 4. In FIG. 4, reference numeral 4A denotes light incident on the thinnest portion at which the thickness of the resin layer 2 defined by the bottom of the receding surface 21 is smallest, and reference numeral 4B denotes the reflected light thereof. Reference numeral 5A denotes light incident on a portion around the thinnest portion, and reference numeral 5B denotes the reflected light thereof. Reference numeral 6A denotes light incident on the thickest portion at which the thickness of the resin layer 2 defined by the reference surface 22 provided outside the receding surface 21 is largest, and reference numeral 6B denotes the reflected light thereof.

In FIG. 4, since the transmission loss of the incident light 4A in the resin layer 2 is small at the thinnest portion, the amount of light reflected by the reflective layer 3 is large, making the colored resin layer 2 look pale and bright when viewed from the front surface 2b. As the thickness of the resin layer 2 increases from the bottom of the receding surface 21 toward the peripheral portion, the transmission loss of the incident light 5A in the resin layer 2 increases and the normal direction of the front surface of the reflective layer 3 becomes lateral gradually and continuously, and thereby the regular reflectance of the reflective layer 3 decreases. Moreover, the amount of light reflected in a direction veering away from the incident direction increases, like the reflected light 5B. This makes the colored resin layer 2 look deep in color and dark. At a portion right above the peripheral portion of the receding surface 21, the darkness reaches its peak and the resin layer 2 looks blackish. In contrast, at the thickest portion located further outside, since the reflective layer 3 is parallel to the front surface 2b, the regular reflectance of the reflective layer 3 is the same as that of the thinnest portion, and the reflected light 6B decreases by the amount of the transmission loss of the incident light 6A caused by the increase of the thickness. As a result, at the thickest portion, the colored resin layer 2 looks deeper in color than at the thinnest portion and paler than at the portion right above the peripheral portion of the receding surface 21.

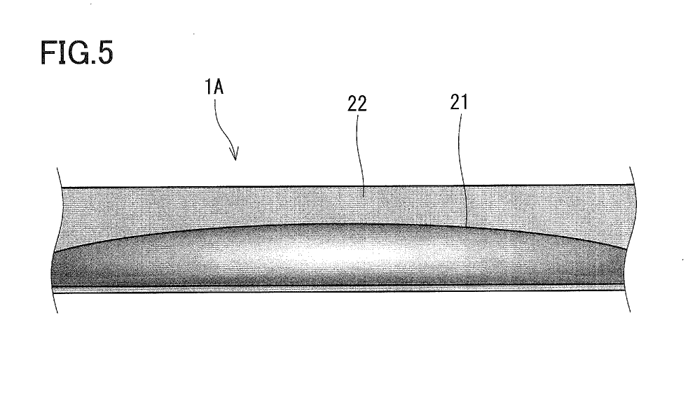

By changing the thickness of the colored resin layer 2 in a curved form and providing the reflective layer 3 on the back side of the resin layer 2, it is possible to express a gradational pattern having a three-dimensional visual effect, as shown in FIG. 5.

As described above, in the decorative member 1A of the present embodiment, by changing, with the receding surface 21, the thickness of the colored resin layer 2, it is possible to form, on the convex portion formed by providing the reflective layer 3 along the receding surface 21, a gradation of color that is pale at the thin portion of the resin layer 2 and deep at the thick portion of the resin layer 2. Moreover, because of the transmission loss of light in the resin layer 2 and the reflection of light by the reflective layer 3, the convex portion of the reflective layer 3 along the receding surface 21 looks bright at the thin portion of the resin layer 2 and dark at the thick portion of the resin layer 2. With such a gradation having not only the lightness/depth of color but also the contrast of light utilizing the reflection of light, the convex portion of the reflective layer 3 has a distinctly raised appearance. Thereby, a high three-dimensional visual effect can be obtained.

Furthermore, in the decorative member 1A of the present embodiment, since the receding surface 21 is curved continuously, it is possible to change gradually and minutely the lightness/depth of color and the contrast of light in the gradation from the thin portion of the resin layer to the thick portion of the resin layer. Moreover, the degree of the gradation formed on the convex portion of the reflective layer 3 varies in accordance with the angle at which the decorative member 1A is viewed. Thereby, the three-dimensional visual effect can be accentuated further.

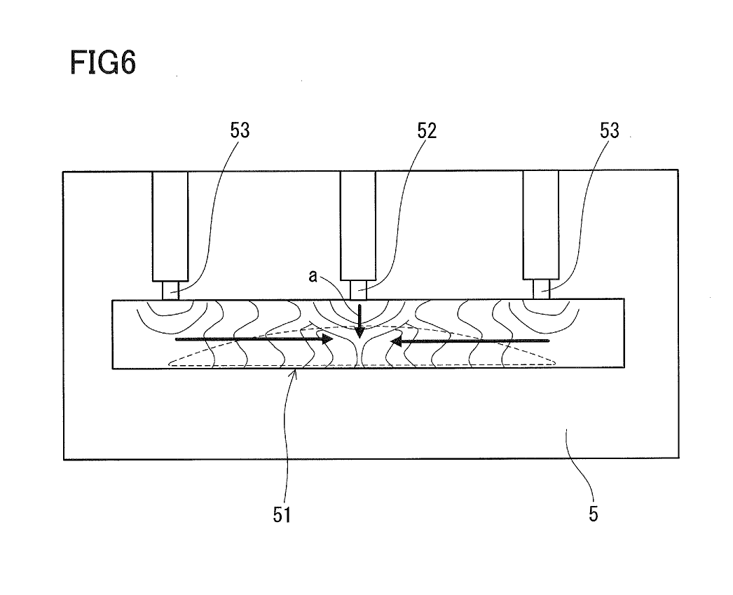

Next, the method for injection-molding the resin layer 2 for the decorative member 1A will described with reference to FIG. 6. In this method, a metal mold 5 having a molding chamber 51 with the same shape as that of the resin layer 2 is used. The metal mold 5 has a first gate 52 provided at a position corresponding to the lowest part of the molding chamber 51, that is, at a position corresponding to the bottom of the receding surface 21, and second gates 53 provided at positions spaced apart from each other in a longer direction of the molding chamber 51 with the first gate 52 being located therebetween.

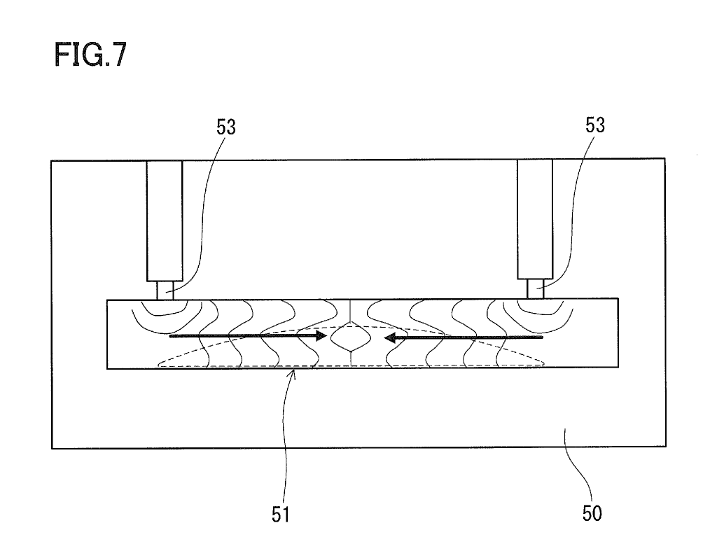

In the case where a metal mold 50 without the first gate 52, as shown in FIG. 7, is used, when a melted resin is injected from the second gates 53 into the molding chamber 51, the melted resin flows more slowly at a low part of the molding chamber 51 than at a high part, and thus the lowest part of the molding chamber 51 located at an approximate center of the molding chamber 51 is the final filling position. For this reason, the air in the molding chamber 51 cannot escape, causing gas burning in the metal mold 50. In addition, a weld is formed on the molded resin layer 2.

In contrast, in the injection molding method of the present embodiment, by using the metal mold 5 as shown in FIG. 6, a melted resin is injected from the second gates 53 into the molding chamber 51, and then, before the melted resin fills the molding chamber 51 completely, a valve (not shown) is opened to inject a melted resin from the first gate 52 into the molding chamber 51 as indicated by an arrow a. This allows the final filling position to shift from the center of the molding chamber 51 to a position around it. As a result, it is possible to prevent the gas burning in the metal mold 5 and to mold the weldless resin layer 2.

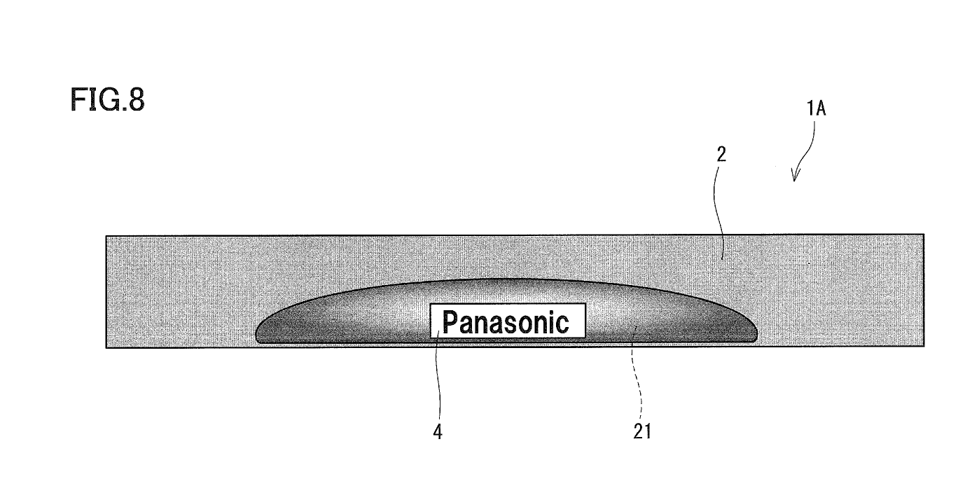

As shown in FIG. 8, a label 4 bearing a character or a mark may be stuck on the front surface 2b of the resin layer 2, at the thinnest portion of the resin layer 2. This makes it possible to hide a gas burning mark on the resin layer 2, if any.

### Embodiment 2

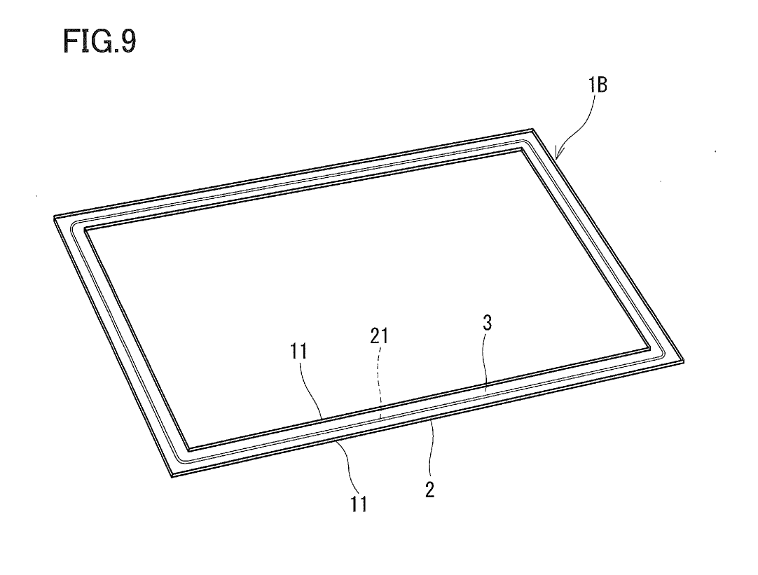

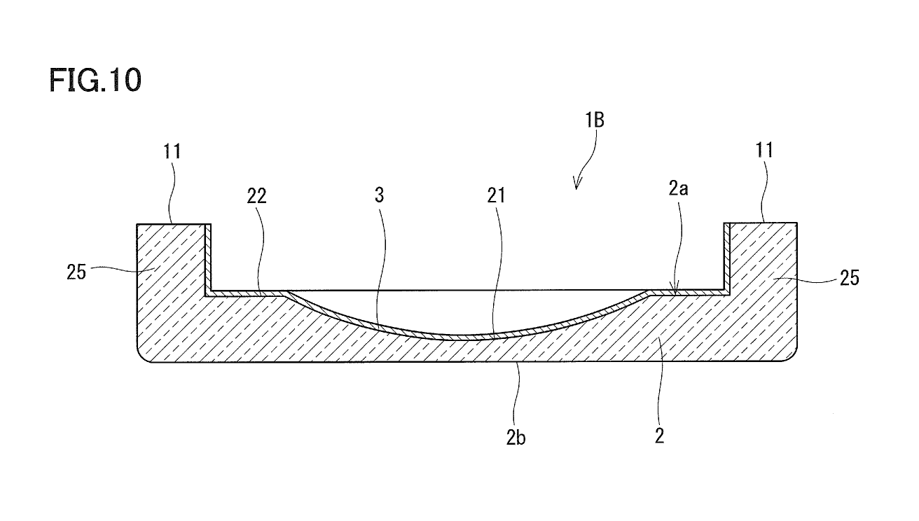

Next, FIGS. 9 and 10 show a decorative member 1B according to Embodiment 2 of the present invention. In the present embodiment, the same components as those in Embodiment 1 are indicated with the same reference numerals, and the descriptions thereof are omitted.

The decorative member 1B of the present embodiment is formed in a rectangular frame shape that opens in the thickness direction of the resin layer 2. The cross-sectional shape of one side of the decorative member 1B is an approximate U shape. More specifically, an inner periphery and an outer periphery of the decorative member 1B each are provided with a rectangular cylindrical rib 11 protruding to the back side. The rib 11 is composed of a protruding portion 25 protruding from each of two end portions of the resin layer 2, and the reflective layer formed on each of internal surfaces of the protruding portions 25 facing each other.

Furthermore, in the present embodiment, the receding surface 21 is provided so that the receding surface 21 extends along all of the sides of the rectangular frame shape of the decorative member 1B and portions of the receding surface 21 extending along the respective sides are joined to each other. That is, the receding surface 21 is formed in a square shape in the entire circumference of the back surface 2a of the resin layer having an opening at its center.

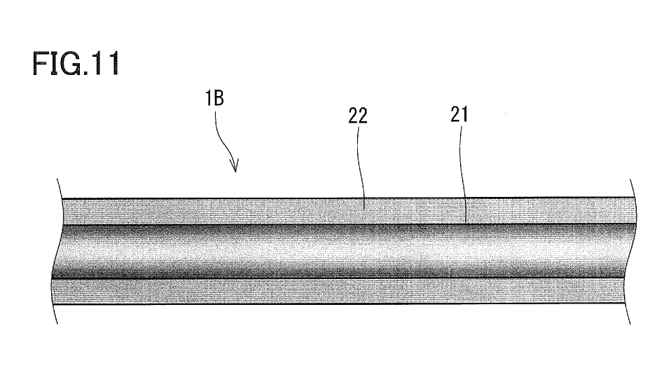

On each of the sides the decorative member 1B, the receding surface 21 of the present embodiment is a concave surface forming a groove-like depression extending in a longer direction of the side. More specifically, the concave surface has a cylindrical shape curved continuously along only a shorter direction of each of the sides of the decorative member 1B. Thereby, a gradational pattern, as shown in FIG. 11, having a three-dimensional visual effect is expressed on each of the sides of the decorative member 1B.

Also in the gradation shown in FIG. 11, the lightness/depth of color and the contrast of light in the gradation change gradually and minutely from the thin portion of the resin layer to the thick portion of the resin layer, as in Embodiment 1. Furthermore, outside the receding surface 21, the colored resin layer 2 looks to have an intermediate color and brightness of the gradation. Therefore, the same effects also can be obtained in Embodiment 2 as in Embodiment 1.

In the case where the decorative member 1B is formed in a rectangular frame shape as in the present embodiment, the receding surface 21 may be provided so as to extend along at least one side of the rectangular frame shape.

### Modification

Although the front surface 2b of the resin layer 2 is a flat surface in Embodiments 1 and 2, the front surface 2b of the resin layer 2 may be bowed or may be formed with an undulation, for example. Moreover, the reference surface 22 of the back surface 2a of the resin layer 2 does not necessarily have to be a flat surface perpendicular to the thickness direction of the resin layer 2. For example, in the case where the front surface 2b is bowed, the reference surface 22 may be a bowed surface parallel to the front surface 2b.

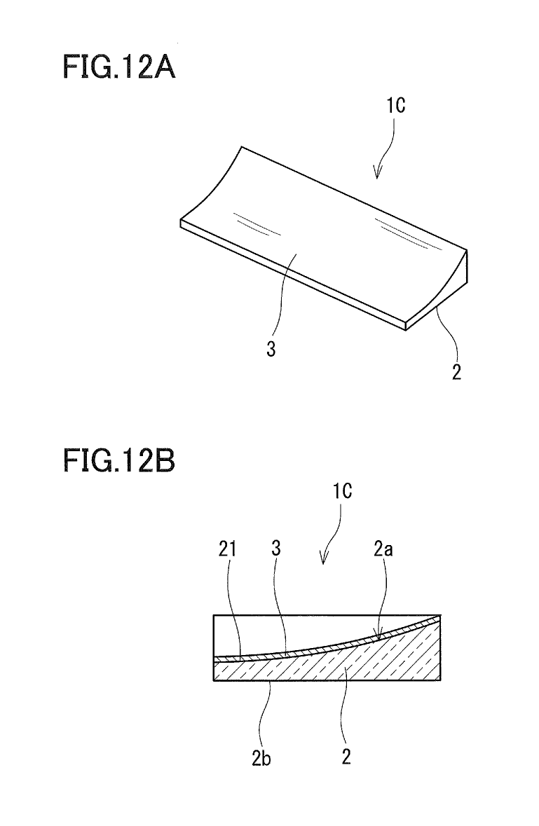

Alternatively, like a modified decorative member 1C shown in FIGS. 12A and 12B, the receding surface 21 may be formed over the entire back surface 2a of the resin layer 2. However, with the reference surface 22 being provided outside the receding surface 21 as in Embodiments 1 and 2, the darkness at an edge of the receding surface 21 is accentuated in comparison with the reference surface 22 and a higher three-dimensional visual effect can be obtained.

Furthermore, the receding surface 21 does not necessarily have to be a concave surface forming a depression that opens while broadening. As shown in FIG. 12B, the receding surface 21 may have a cross-sectional shape that extends from one end to the other end so as to only come closer to the front surface 2b, in the direction in which the receding surface 21 is curved.

Alternatively, in the decorative member 1A according to Embodiment 1, a concave surface having a cylindrical shape curved continuously along the one direction perpendicular to the thickness direction of the resin layer, as in Embodiment 2, may be employed as the receding surface 21. Or in the decorative member 1B according to Embodiment 2, a concave surface having a dome shape curved continuously along two directions perpendicular to each other and to the thickness direction of the resin layer 2, as in Embodiment 1, may be employed as the receding surface 21.

### INDUSTRIAL APPLICABILITY

The present invention is useful for decorative members to be used for providing high quality decoration to casings of electrical devices, etc.

1. A decorative member comprising:
a colored light-transmissive resin layer having a front surface and a back surface, the back surface including a receding surface formed therein, the receding surface receding gradually toward the front surface to change a thickness that is a distance between the front surface and the back surface; and
a reflective layer formed on the back surface of the resin layer so as to cover the receding surface,
wherein the receding surface is curved continuously along at least one direction perpendicular to a thickness direction of the resin layer so as to be convex toward the front surface.

2. The decorative member according to claim 1, wherein the receding surface is a concave surface forming a depression that opens while broadening.

3. The decorative member according to claim 2, wherein the concave surface has a cylindrical shape curved continuously along the one direction perpendicular to the thickness direction of the resin layer.

4. The decorative member according to claim 2, wherein the concave surface has a dome shape curved continuously along two directions perpendicular to each other and to the thickness direction of the resin layer.

5. The decorative member according to claim 1, wherein the back surface of the resin layer includes a reference surface outside the receding surface, and the reference surface also is covered with the reflective layer.

6. The decorative member according to claim 5, wherein the reference surface is a flat surface perpendicular to the thickness direction of the resin layer.

7. The decorative member according to claim 1, wherein the front surface of the resin layer is a flat surface perpendicular to the thickness direction of the resin layer.

8. The decorative member according to claim 1, wherein the reflective layer has a metallic color.

9. The decorative member according to claim 8, wherein the reflective layer is composed of a coating film formed by coating or printing, a metal film formed by vapor deposition, or a sheet bonded to the back surface of the resin layer.

10. The decorative member according to claim 1, wherein the decorative member extends in a specified direction and the receding surface extends in a longer direction of the decorative member.

11. The decorative member according to claim 1, wherein the decorative member is formed in a rectangular frame shape that opens in the thickness direction of the resin layer, and the receding surface is provided so as to extend along at least one side of the rectangular frame shape.

12. The decorative member according to claim 1, wherein a label bearing a character or a mark is stuck on the front surface of the resin layer, at the thinnest portion of the resin layer.

13. An injection molding method for molding the resin layer for the decorative member according to claim 10, the injection molding method comprising the step of,
by using a metal mold having a molding chamber with the same shape as that of the resin layer, a first gate provided at a position corresponding to the lowest part of the molding chamber, and second gates provided at positions spaced apart from each other in a longer direction of the molding chamber with the first gate being located therebetween, injecting a melted resin from the second gates into the molding chamber and then injecting a melted resin from the first gate into the molding chamber.
